(19) United States
(12) Patent Application Publication
(10) Pub. No.: US 2008/0099586 A1
(43) Pub. Date: May 1, 2008

(54) Device For Delivering A Biologically Active Composition

(76) Inventor: Hans Almer Middelbeek, Boxmeer (NL)

Correspondence Address: INTERVET INC.;PATENT DEPARTMENT, PO BOX 318, MILLSBORO, DE, 19966-0318, US

(21) Appl. No.: 11/628,916

(22) PCT Filed: Jun. 6, 2005
(86) PCT No.: PCT/EP05/52576

§ 371 Date: Aug. 21, 2007

(30) Foreign Application Priority Data
Jun. 7, 2004 (EP) 04102560.2
Apr. 26, 2005 (EP) 05103380.1

(51) Int. Cl. B05B 1/02

(52) U.S. Cl. 239/589

(57) ABSTRACT

The invention relates to a device for delivering a biologically active composition comprising a nozzle head provided with at least one opening, and a pump for pumping the biologically active composition through the at least one opening so as to obtain a spray of droplets of said composition, to a plate for use in such a device, to a kit comprising a biologically active composition and such a plate, to the use of such a device for delivering a biologically active composition and to methods of making droplets comprising a biologically active composition through such a device.

The invention relates to a device for delivering a biologically active composition comprising a nozzle head provided with at least one opening, and a pump for pumping the biologically active composition through the at least one opening so as to obtain a spray of droplets of said composition, to a plate for use in such a device, to a kit comprising a biologically active composition and such a plate, to the use of such a device for delivering a biologically active composition and to methods of making droplets comprising a biologically active composition through such a device.

In several fields of industry where the application of biologically active materials is needed, spraying techniques are applied. A few examples of spray applications in various fields are described below.

In the field of agriculture, spraying techniques are frequently used in crop protection. Spraying is a quick way of applying biologically active compositions such as pesticides, fungicides, herbicides and plant growth regulators to fields, soil, plants or crops to be treated.

The use in such applications of very large droplets, i.e. droplets with a diameter of >1000 micron is not attractive because this would give an unequal distribution of the composition, with spots having a very high concentration of the biologically active composition and spots where no biologically active composition is present.

The use of very small droplets would give a very even distribution of the composition, but has the disadvantage that external factors such as wind could easy blow away most of the sprayed volume. This is highly disadvantageous if only from an environmental point of view: the biologically active composition would be carried away to area where it is not needed nor wanted. And next to this, small droplets have a very high surface to volume ratio which makes their speed of evaporation highly dependent of the atmospheric humidity.

And even if droplets can be obtained with a predetermined droplet size, most nozzles used for spraying provide droplets of which the statistic size distribution follows a bell-shaped curve having very broad basis. Thus, a significant part of the droplets is too large or too small.

In view of this, it is clear that for spraying purposes, droplets of equal size are desired. The size of the droplets can then be adapted to the specific use, such as soil application or application onto leaves of crop, and they can be compensated for e.g. wind force or humidity. Such equally sized droplets are however difficult to obtain.

Several ways of attacking this problem have been described in the prior art, but they rely on either high pressure systems, complex and thus expensive nozzles having electrical and/or moving parts, or a combination of the two.

U.S. Pat. No. 5,518,183 describes a nozzle comprising an array of slots (grooves) in a conical plug and seat. Such a device requires a relatively high pressure of >40 psi (>2.6 bar) in order to produce the desired droplet size and, due to the very small size of the grooves is complex to produce.

Other spray systems such as those described in UK Patent application GB 2 206 063 use relatively complex nozzles in which splayed outlet tubes are arranged in order to obtain droplets of more or less equal size. Still other nozzles, such as the one described in PCT application WO 99/25482 use a complex variable flow control device using a metering rod movably mounted within a housing or, in WO 2004/23865, a moving metering unit and a flexible spray tip. In these nozzles, the fact that the droplet size can be varied is more important than homogeneity in droplet size.

Therefore, although the known nozzles all provide smaller or larger droplets, there is a relatively large spreading in droplet size. This spreading can only be diminished, at least partially, by using complex nozzle design.

In animal breeding, spraying techniques are often used for administering vaccines to animals, especially in chicken breeding.

International patent application WO 00/04920 relates to a method of vaccinating poultry by spraying the poultry with an effective amount of a live a viralent derivative of an enteropathogenic bacteria. It is stated in WO 00/04920 (page 8, line 22 ff.) that “it is believed that the administration of a vaccine or immunogenic composition as a coarse spray allows the spray droplets to contact the body surface while minimizing the amount of the vaccine that is inhaled into the respiratory system. This is to be distinguished from a spray of very fine droplets or mist, such as commonly referred to as an aerosol in which droplets have a diameter of less than about 40 microns. Unlike the aerosol sprays, the coarse spray of the present invention is believed to not be deeply inhaled which assists in avoiding the development of respiratory infections seen with some spray vaccination . . . it is preferred that the spray have less than about 1% of the droplets in a size range of less than about 12 microns.”

It is further stated in WO 00/04920 that the type of spray equipment that is used for the administration of the vaccine is not critical and that almost any type of spray vaccination equipment capable of dispensing a coarse spray can be used. Reference is made to, amongst others, U.S. Pat. No. 4,316,464 and U.S. Pat. No. 4,449,968.

U.S. Pat. No. 4,316,464 relates to a method of vaccinating poultry wherein baby chicks are loaded in an open top container (numeral 32 in the drawings of U.S. Pat. No. 4,316,464) and the container is moved into an open ended cabinet (18). In response to the movement of the container into the cabinet, a dose of vaccine is drawn from a supply (56) and delivered to a pressure chamber (41), and in response to the delivery of the dose of vaccine to the pressure chamber, air pressure is also delivered to the pressure chamber so as to eject the dose of vaccine from the pressure chamber and through at least two nozzles (42) supported in the upper portion of the cabinet. It is mentioned in U.S. Pat. No. 4,316,464 that the spray ejected from the nozzle is of a droplet size large enough to fall onto the chicks in the container substantially without remaining airborne long enough to be inhaled by the chicks. The nozzles (42) in the disclosed embodiment have a nozzle throat of approximately 0.039 inches (˜1 mm) diameter for a conical spray pattern at an angle of approximately 80 degrees. With a backpressure of about 35 psi (˜2,4 bar), the vaccine, which has a viscosity about the same as water, moves through the nozzle at a rate of about one gallon per hour.

U.S. Pat. No. 4,449,968 relates to a method of vaccinating poultry comprising placing a multiple number of chicks in an open top container, moving the container along a path until the container is located beneath at least one spray nozzle, ejecting a vaccine spray from the nozzle downwardly onto the upper portions of and into the eyes of the chicks in droplets wherein at least about 80 percent of the droplets are in a size range from about 90 microns in diameter to about 190 microns in diameter. In U.S. Pat. No. 4,316,464 and its continuation in part U.S. Pat. No. 4,449,968, droplets within this range can only be obtained using high pressure (2.4 bar) and a nozzle with a large orifice having a 1 mm diameter.

U.S. Pat. No. 4,674,490 relates to an apparatus for aerosol immunization of subjects such as day old chicks and the like, which apparatus comprises a kinetic energy nozzle (46) such as a spinning disc, which is driven by a motor.

It is an object of the present invention to provide a device that generates droplets having a droplet size that is not only well-defined, but also within a very small size range. It is one of the merits of the present invention that it allows to further reduce the amount of very fine droplets and aerosol in spraying, especially in spray vaccination.

In order to obtain this objective, the pumping of the biologically active composition is performed at a pressure which is sufficiently low to expel the composition from the at least one, preferably circular, opening in the form of a jet which breaks up into droplets.

If was found that by expelling jets, which, under the influence of surface tension, gradually break up into droplets, instead of forming a spray directly at the opening(s), the amount of very fine droplets and aerosol can be further reduced.

Although the said pressure can be established quickly by trial and error and will depend on the diameter of the opening(s) and the properties of the biologically active composition, in particular viscosity, and to a lesser extent of the length and the shape of the opening(s), a pressure around 2.4 bar will not be needed, a pressure not exceeding 2 bar will usually be sufficient. It is generally preferred that the pressure is in a range from 0.1 to 1.5 bar, preferably 0.2 to 1.0 bar. The pressure as given is understood to be the over-pressure compared to the atmospheric pressure. A low pressure of e.g. 0.1 bar can be obtained using a small pump, but it can even be obtained by placing a reservoir comprising the composition to be sprayed one meter above the device comprising the nozzle. Gravity is sufficient to provide for such low pressures. For the purpose of this invention, therefore the option of using gravity is considered to be included in the wording “use of a pump”.

The invention thus relates to a device for delivering a biologically active composition comprising a nozzle head provided with at least one opening, and a pump for pumping the biologically active composition through the at least one opening so as to obtain a spray of droplets of said composition, wherein the device has as a characteristic that the diameter of the at least one opening and the operating pressure of the pump are such that, upon operating the pump, the biologically active composition is expelled from the at least one opening in the form of a jet which breaks up into droplets.

A further important advantage of the device according to the invention is, that due to the structure of the device, as will be explained below, the shear forces at the outside of the opening are very low, compared to other devices. This makes the device very suitable for vaccination with not only vaccines comprising viruses, but also vaccines comprising live bacteria and even live parasites. Bacteria, which are comparatively large, and parasites which are even larger are very vulnerable to such shear forces. Merely as an example: a French Press, used for efficiently breaking up bacteria, consists basically of an apparatus in which bacteria are pressed through a small opening under high pressure. The device according to the invention does not suffer from this problem because as stated above, the vaccine is expelled from the at least one opening in the form of a jet which breaks up into droplets.

In view of this, another important advantage of the low shear forces of the devise lies in its use in freeze-drying of vaccines comprising live, possibly attenuated viruses, bacteria and parasites. The device according to the present invention can easily deliver a biologically active composition to a vacuum chamber. The viruses, bacteria or parasites of the biologically active compositions delivered in this way are hardly or not attacked by shear forces and the droplet size is distributed in a very narrow band gap, thus ensuring little or no damage to (the components of) the composition, an equal time of drying and an equally dispersed end product.

In order to obtain these advantages to the full extent, it is preferred that the at least one opening has a diameter in a range from 50 to 500 μm, preferably from 65 to 400 μm, more preferably from 75 to 300 μm, even more preferably from 100 to 200 μm.

It is further preferred that the pressure is sufficiently low to obtain a spray of droplets of which less than 10%, preferably less than 5%, more preferably less than 2% has a diameter of less than 100 μm. Therefore, in a more preferred form of this embodiment, the operating pressure of the device is in a range from 0.1 to 1.5 bar, even more preferably the lower limit of the pressure applied is 0.2, 0.3, 0.4 or 0.5 bar in that order of preference and the upper limit of the pressure applied is 1.3 bar, 1.2, 1.1, 1.0, 0.9 or 0.8 bar in that order of preference.

Due to the low pressure that is applied, the amount of the biologically active composition that can be sprayed per opening per unit of time is relatively low. This problem can easily be solved by providing the nozzle head with a plurality of openings.

The number of openings will depend on the use of the nozzle. If the nozzle is used for e.g. the spraying of vast areas of crop, a plurality of nozzle heads, each with 100 to 500 openings would be preferred, because this would allow vast areas to be sprayed within a short time. Therefore, in a still even more preferred form of this embodiment, the nozzle head is provided with a plurality of openings.

If the nozzle head is used for vaccination purposes, the number of openings would be preferably in a range from 5 to 100, more preferably in a range from 10 to 60 openings.

If the nozzle head comprises a plurality of openings, it is further preferred that the openings are arranged along part of the circumference of the nozzle head. Thus, a spray spanning e.g. 60 degrees or more can be obtained, which significantly increases the efficiency of the vaccination procedure.

Therefore, in a most preferred form of this embodiment, the plurality of openings are arranged along part of the circumference of the nozzle head.

In addition to the preferred forms described above, it would be preferable that, in the device according to the invention, the nozzle head comprises a chamber for holding an amount of the vaccine and wherein the openings communicate with this chamber.

A device according to the invention would for large scale agricultural applications such as e.g. the spraying of a pesticide preferably be mounted to a vehicle such as a tractor, because it would comprise a plurality of devices according to the present invention. For mass vaccination, the device could be mounted on a small vehicle. For the small scale application of e.g. the spraying of boxes of chickens, a hand-held device would be more convenient. Therefore, in a preferred embodiment the device is portable. It can of course still comprise more than one nozzle head, but it can at least be carried by man.

Another embodiment of the invention relates to a plate, which can be detachably mounted on or to the nozzle head and wherein said plate comprises at least one opening. The desired effect of obtaining droplets of a well-defined range and within narrow size band is best obtained using a relatively thin plate. If a thick plate is used, the shape of the opening will become tube-like. The diameter of the opening will inevitably become small compared to the length of the opening. This in turn leads to unwanted turbulence along the wall of the opening, causing shear of the fluid at the outside of the opening, which results in a spray of droplets with undefined size. Thus, in a preferred form, the plate has a thickness that does not exceed 1 mm. More preferably the thickness of the plate is in a range from 0.1 to 0.8 mm.

In a more preferred form of this embodiment, the at least one opening has a diameter in a range from 50 to 500 μm, preferably from 65 to 400 μm, more preferably from 75 to 300 μm, even more preferably from 100 to 200 μm.

Still another embodiment of the present invention relates to a kit comprising a biologically active component, preferably a pesticide, fungicide, herbicide, a plant growth regulator or a vaccine, in particular a vaccine for poultry, and such a plate. Thus, the plate and the openings in the plate can be adapted to the biologically active component in the kit and/or the plate can be disposed of after use, avoiding the need for cleaning the plate and preventing the plate from fouling or clogging and from being used in conjunction with another biologically active component.

Again another embodiment of the present invention relates to the use of a device according to the invention for delivering a biologically active composition to plants, crops or soil.

In a preferred form of this embodiment, the biologically active composition is a pesticide, a fungicide, a herbicide or a plant growth regulator.

Still another embodiment of the present invention relates to a method for the preparation of droplets comprising a biologically active composition, characterised in that said method comprises conducting said composition through a device according to the invention.

The invention will now be explained in more detail with reference to the drawings, which schematically show a presently preferred embodiment.

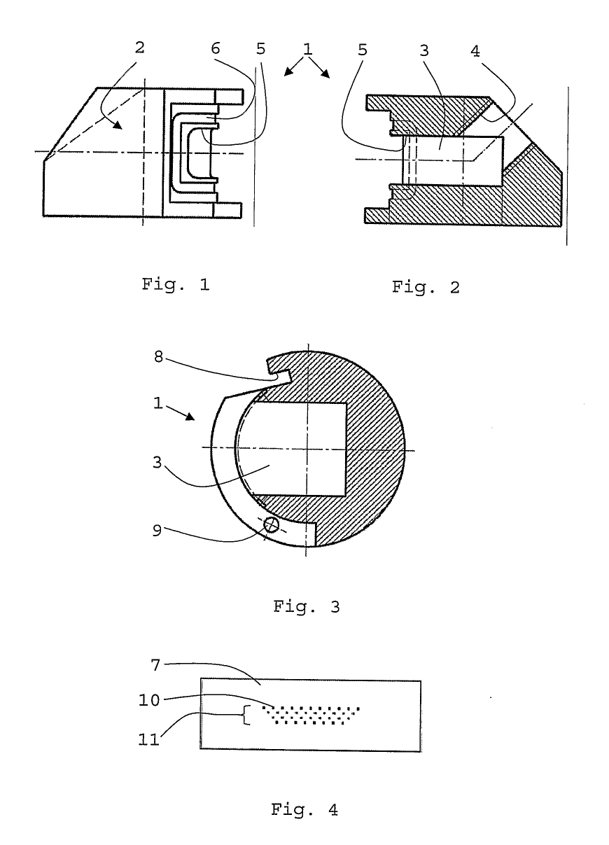

FIG. 1 is a side view of a nozzle head in accordance with the present invention.

FIGS. 2 and 3 are respectively vertical and horizontal cross-sections of the nozzle head according to FIG. 1.

FIG. 4 is a front view of a nozzle plate for use in the nozzle head according to FIG. 1.

FIGS. 1 to 3 show a nozzle head 1 for spraying a biologically active component, preferably for spraying pesticides, fungicides, herbicides and plant growth regulators or for vaccinating livestock, in particular poultry such as chickens, in accordance with the present invention. This nozzle head 1 has a substantially cylindrical outer wall 2 and contains a chamber 3 for holding a liquid vaccine, which chamber 3 is provided with a internally threaded inlet 4 that can be attached to a supply, e.g. an externally threaded, rigid, hollow tube which in turn is connected, via a flexible hose, to a portable tank. The tank is provided with a hand-operated pump and operatively connected to a handheld valve, which is located e.g. at the interface between the hose and the tube, in a manner known in itself. The chamber 3 also has a curved (when seen from the top) outlet opening 5, which is surrounded by a groove 6 for receiving a gasket, such a rubber ring (not shown). During spraying, the outlet opening is covered by a resilient plate 7, shown in FIG. 4 and having a length and height of e.g. 4×2 cm. To be able to mount the plate 7 on the nozzle head 1, the nozzle head 1 is provided, in this example, with a slot 8 on its left side, and a pin 9 on its right side. The plate 7 can be installed by hooking its left end in the slot 8, bending the plate 7 until its right end fits behind the pin 9, and releasing the plate 6, which will subsequently pull itself sealingly onto the above-mentioned gasket.

The plate 7 has a thickness preferably in a range from 0.1 to 0.8 mm, in this example 0.5 mm, and comprises a plurality of circular openings 10, e.g. 38 openings arranged in a staggered pattern 11 at a pitch of 1.5 mm. The openings have a diameter in a range from 50 to 300 μm, e.g. 150 μm, and a length that corresponds to the thickness of the plate. Optionally, the openings 10 may be provided with a frusto-conical lead-in section.

Once the plate 7 has been installed, the pattern 11 spans an arc of approximately 80 degrees.

The nozzle head is preferably made of a metal, such as stainless steel, or an injection moulded polymer, such as PE or POM. The plate is preferably also made of stainless steel or a polymer, while the openings are preferably manufactured by laser cutting.

During use, the above-mentioned tank is filled with a liquid, usually water, containing the a biologically active component, preferably a pesticide, fungicide, herbicide or plant growth regulator or a vaccine, and pressurised by means of the hand-operated pump to a pressure in a range from 0.2 to 1.0 bar, depending on how far the droplets should be spread (a higher pressure will result in wider spreading). The tank is mounted on the back of an operator. Vaccination is carried out by opening the handheld valve, expelling the vaccine at a flow rate of e.g. about 300 ml/min, moving the nozzle head repeatedly from left to right while slowly walking forwards, similar to e.g. spraying herbicides on crops or a lawn. Thus, an entire chicken farm can be vaccinated relatively quickly and efficiently.

Laboratory tests have shown that the vaccine is expelled from the openings in jets, which gradually break up into droplets at a distance of approximately between 2 and 4 cm.

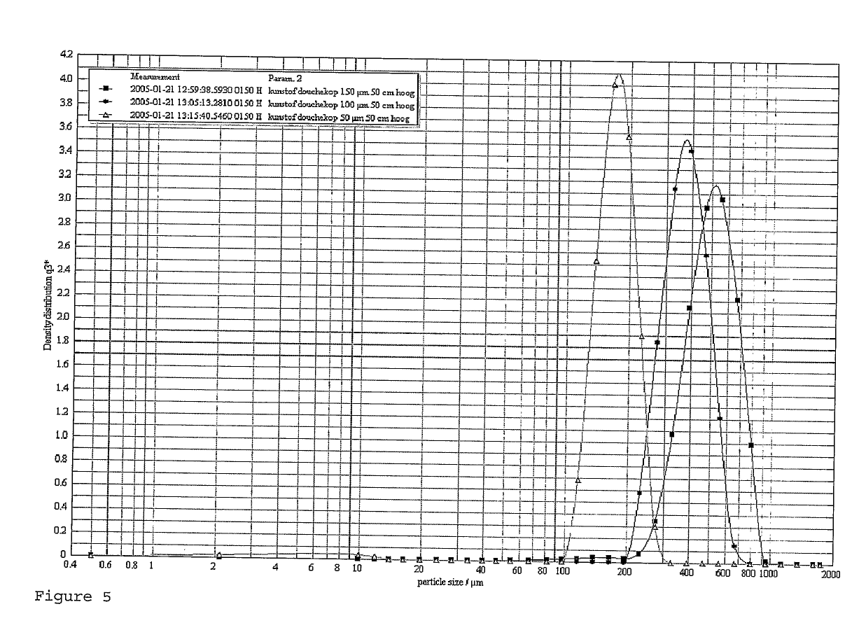

In a first experiment using the devise according to the invention, the plate having a thickness of 0.5 mm and pressure being 0.5 bar, a rough estimation of the particle size distribution was made in relation to the diameter of the opening used: 50, 100 or 150 μm diameter, using a Sympatec Helios KF/magic for the determination of the particle size. The data are presented in FIG. 5. As follows immediately from this figure, the distribution of the particle size is within a narrow band gap which correlates nicely to the size of the opening used and additionally the contribution of particles having a size below 100 respectively 200 μm is indeed extremely low.

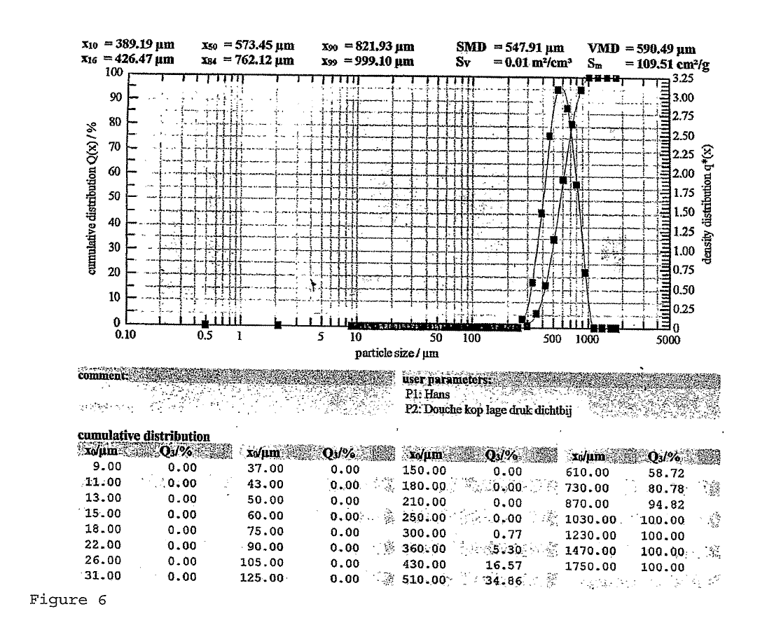

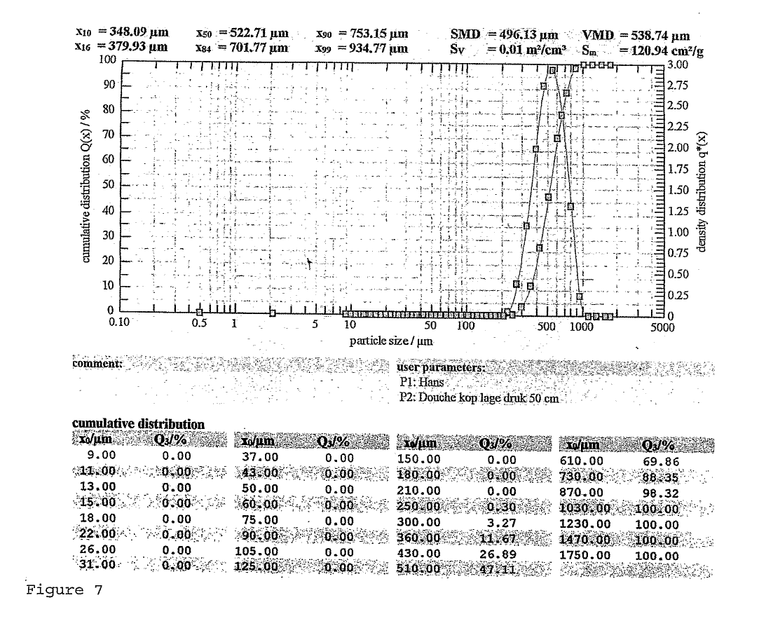

In a second experiment using the devise according to the invention, the pressure being 0.5 bar and the plate having a thickness of 0.5 mm and a diameter of the opening of 150 μm, a precise determination of the resulting particle size distribution (the Q3/%) at a distance of 10 cm and 50 cm from the opening was measured at 20° C. and an air humidity of 75%, again using a Sympatec Helios KF/magic. The data are presented in FIG. 6 (10 cm distance) and FIG. 7 (50 cm distance).

It can be seen from FIG. 6, that at 10 cm from the device 0.00% of the droplets have a diameter less than 250 μm, and the average size of the droplets is between 500 and 600 μm.

From FIG. 7 it follows that at 50 cm from the device 0.00% of the droplets have a diameter less than 210 μm, and the average size of the droplets is between 500 and 600 μm. The (minor) difference between droplet size in FIGS. 6 and 7 is due to the normal evaporation of the droplets.

With the device according to the present invention, biologically active compositions such as pesticides, fungicides, herbicides and plant growth regulators can be applied to fields or crops to be treated, at low pressure, using the simple and cheap device according to the invention, at the same time providing droplets of a homologous and well defined size. For vaccination purposes, using the device according to the present invention, the amount of the vaccine that is inhaled into the respiratory system of the chickens, and the damage to the respiratory tissue resulting from rest virulence of the inhaled vaccine, are further reduced or even avoided. An additional advantage resides in that, under some circumstances, the ventilation of a farm where vaccination is carried out need not be shut down, as is usually done during vaccination.

The invention is not restricted to the above-described embodiments, which can be varied in a number of ways within the scope of the claims. For instance, instead of employing a hand-operated pump, other pumps, such as pumps driven by an electric motor are also suitable. Further, for vaccination purposes, instead of being part of a mobile device the nozzle head can be part of a fixed mount, through which the animals to be vaccinated can be transported.

1. Device for delivering a biologically active composition comprising a nozzle head provided with at least one opening, and a pump for pumping the biologically active composition through the at least one opening so as to obtain a spray of droplets of said composition, wherein the diameter of the at least one opening and the operating pressure of the pump are such that, upon operating the pump, the biologically active composition is expelled from the at least one opening in the form of a jet which breaks up into droplets.

2. Device according to claim 1, wherein the at least one opening has a diameter in a range from 50 to 500 μm.

3. Device according to claim 1, wherein the operating pressure is in a range from 0.1 to 1.5 bar.

4. Device according to claim 1, wherein the nozzle head is provided with a plurality of openings.

5. Device according to claim 4, wherein the openings are arranged along part of the circumference of the nozzle head.

6. Device according to claim 1, wherein the nozzle head comprises a chamber for holding an amount of the vaccine and wherein the openings communicate with this chamber.

7. Device according to claim 1, which is portable.

8. Device according to claim 1, wherein the nozzle head comprises a plate, which has been detachably mounted on or to the nozzle head and wherein at least one opening is part of this plate.

9. (canceled)

10. Plate for use in a device according to claim 8, which plate can be detachably mounted on or to the nozzle head and which comprises at least one opening.

11. Plate according to claim 10, wherein the at least one opening has a diameter in a range from 50 to 500 μm.

12. Kit comprising a biologically active component, and a plate in accordance with claim 10.

13. Method for the preparation of droplets comprising a biologically active composition, wherein the method comprises conducting said composition through a device according to claim 1.

14. A device according to claim 1, wherein the at least one opening has a diameter in a range from 65 to 400 μm.

15. A device according to claim 1, wherein the at least one opening has a diameter in a range from 75 to 300 μm.

16. A device according to claim 1, wherein the at least one opening has a range from 100 to 200 μm.

17. A plate according to claim 10, wherein the at least one opening has a diameter in a range from 65 to 400 μm.

18. A plate according to claim 10, wherein the at least one opening has a diameter in a range from 75 to 300 μm.

19. A plate according to claim 10, wherein the at least one opening has a diameter in a range from 100 to 200 μm.
